(19) United States
(12) Patent Application Publication
(10) Pub. No.: US 2011/0315682 A1
(43) Pub. Date: Dec. 29, 2011

(54) SAFETY ELEMENT FOR A DIESEL FUEL CONTAINER TO PREVENT ADDING THE WRONG FUEL

(75) Inventor: Konstantinos Tsiberidis, Heilbronn (DE)

(73) Assignee: KT PROJEKTENTWICKLUNGS-GMBH, Heilbronn (DE)

(21) Appl. No.: 13/202,763

(22) PCT Filed: Feb. 23, 2010
(86) PCT No.: PCT/EP2010/001112

§ 371 Date: Sep. 9, 2011

(30) Foreign Application Priority Data
Feb. 23, 2009 (DE) 10 2009 009 998.0

(51) Int. Cl. B60K 15/04

(52) U.S. Cl. 220/86.2; 220/4.14

(57) ABSTRACT

The invention relates to an insert element (13) for a diesel fuel container, which can be installed in the filling opening (10) of the container, in particular in a filler neck, for the purpose of filling with diesel fuel using a pump nozzle at the gas station, wherein the insert element (13) comprises an elongated, substantially tubular holding element (16), which can be fitted into the container opening and comprises an inlet side and an outlet side and in which a molded part (18) is held, which is elongated in parallel to the holding element (16) and the free face of which projecting toward the inlet side has an outside diameter that is smaller than the inside diameter of an outlet tube (12) of a diesel pump nozzle, however that is larger than the inside diameter of an outlet tube of a gas pump nozzle. Further, an actuating element is provided, which can be displaced coaxially to the filling opening on the inside wall of the holding element (16) and is arranged so as to remain behind the face of the molded part (18) in the direction of the container interior, wherein said actuating element is able to actuate a closing cap arranged on the outlet side of the holding element (16) when displaced in the direction toward the interior of the container.

The invention relates to an insert element which is to be installed in the filling opening for a container which is intended for diesel fuel, and to a fuel container itself which is provided with elements of the insert element in an integral design. Such fuel containers can be integrated into automobiles or can be embodied as mobile containers in the form of a fuel can or spare can.

The containers have a filling opening by means of which they can be filled, inter alia also at the filling station end using a fuel nozzle which is inserted into the filling opening. Since various fuels can be obtained at a filling station, even at the same fuel pump, there is generally the risk here that a lack of attention will result in gasoline being filled into the fuel container instead of the diesel fuel if the wrong fuel nozzle is selected.

In future, fuel tanks of automobiles are to be provided, during their production, with devices in the filling opening which will prevent such incorrect refueling. It is therefore known, for example according to DE 101 27 751 A1, to provide a cruciform vane element or a tubular molded part integrally in the filler neck of the tank, which cruciform vane element or tubular molded part can be inserted into the outlet pipe of a diesel fuel nozzle, but, because of its size, it does not fit into a gasoline fuel nozzle outlet pipe. There is no solution shown here for the retrofitting of already existing tanks. Moreover, the integral embodiments which are proposed in the specified DE 101 27 751 A1 do not take account of flow properties of the fuel which is being discharged from the fuel nozzle.

The object of the present invention is therefore to condition a fuel container which is intended for diesel fuel, in such a way that the risk of refueling with the wrong fuel at the filling station end is largely eliminated.

This object is achieved by making available an insert element as claimed in claim 1, which insert element can be inserted into a filling opening or a filler neck of a fuel container which is intended for diesel fuel. Alternatively, the object as claimed in claim 10 is achieved by providing a fuel container which can be a fuel tank or a portable canister and in which a specific embodiment of the insert element is integrally implemented.

The basic idea of the invention is to make use of the different outlet pipes of the fuel nozzles of diesel fuel, on the one hand, and the types of gasoline, on the other, in order to prevent refueling of a container intended for diesel with the wrong fuel. All fuel nozzles are standardized in their dimensions at the outlet end of the outlet pipe, wherein the outlet pipes of diesel fuel nozzles have a larger diameter than the outlet pipes of the gasoline fuel nozzles.

According to the present invention, an insert element is provided which is to be inserted into the filling opening or the filler neck of the fuel container, wherein the insert element has an elongated, tubular securing element which can be fitted into the container opening and in which a molded part, which is elongated parallel to the securing element and whose cross-sectional dimension is smaller at its free end side than the internal diameter of an outlet pipe of a diesel fuel nozzle but is larger than the internal diameter of a gasoline fuel nozzle outlet pipe is secured. While, therefore stated in simplified terms, the outlet pipe of a diesel fuel nozzle can be fitted without problems onto the molded part of the insert element, this is not possible for a fuel nozzle outlet pipe for gasoline because the cross section of the molded part prevents fitting on. In addition, an actuation element which can be displaced coaxially on the inner wall of the securing element is provided, which actuation element is arranged set back behind the end side of the molded part in the direction of the outflow side and is capable, when displaced in the direction of the outlet side of the securing element, of actuating a closure flap which is arranged on the outlet side of the securing element after the actuation element. The closure flap can form a tight seal on the remaining filling opening, wherein it can have the sealing lip running around the outside.

In terms of its function, the basic inventive principle results in the situation in which, when the suitable outlet pipe of a diesel fuel nozzle is fitted onto the upper molded part, the outlet pipe end abuts, as the fuel nozzle is pushed in further, against the actuation element and is capable of displacing it in the insertion direction, as a result of which the closure flap is opened.

The molded part can be embodied in the form of a planar vane or else in the form of a circular ring or of a circular ring segment. In the case of a circular ring segment, the molded part advantageously has an angle of substantially 180° to 270° in its cross section.

The closure flap which, in its position of rest, is capable of completely closing the inlet opening into the fuel container is prestressed with a spring. This spring prestress of the closure flap can also advantageously lead automatically to spring prestressing of the actuation element which is also pushed into its position of rest by the closure flap being pushed into the closed position. This occurs, for example, by virtue of the fact that the closure flap exerts a lever effect on the actuation element. This may be the case when the actuation element rests on the closure flap. Of course, it is also possible for the actuation element to be provided with its own spring prestress.

The molded part is advantageously embodied as a thin-walled component, with the result that, in the fitted-on state of a diesel fuel nozzle onto said molded part, a sufficient flow cross section remains in the outlet pipe of the fuel nozzle, as a result of which the diesel fuel can flow in the container. It is clear that the thinner the walls of the molded part in cross section the larger the remaining flow cross section.

Since the molded part has to be fastened at its end lying opposite the filling opening side to the securing element, it must be of a length that the fuel nozzle outlet pipe can be inserted sufficiently deep into the fuel container.

Existing diesel fuel containers can be retrofitted by means of the insert element according to the invention, by virtue of the fact that the insert element, i.e. the substantially tubular securing element, is inserted into a filler neck of the fuel container. It can advantageously be provided for this purpose that the securing element has a stop ring with which the insertion depth of the insert element into the filler neck is limited. In other words, when the insert element is completely inserted the stop ring comes to rest on the opening in the filler neck and closes it off.

In order also to be able to close the insert element, a tubular sleeve can be provided on the filling opening side of the stop ring, which tubular sleeve has an external thread for a closure cover which is provided with an internal thread. Bayonet closure projections, which allow the cover to be closed with complementary latching grooves, can equally be arranged on the tubular sleeve.

According to one advantageous embodiment, the molded part projects over the opening plane of the securing element. When the molded part is in a position arranged in the filler neck of a container, it is therefore located in a clearly visible fashion therein so that when a gasoline fuel nozzle is fitted thereon it is detected immediately why it cannot be introduced into the filler neck of the fuel container, i.e. into the insert element.

In order to lock the tubular securing element in the filler neck of a fuel container there is either provision that the securing element has an external thread on its lateral surface which projects into the filler neck of the container, with which external thread the securing element can be screwed to the closure device for the actual tank cover of the filler neck of the fuel container; alternatively it is possible to provide that bayonet projections, which form a bayonet closure with the closing element which is provided on the filler neck for the actual tank cover, are provided on the lateral surface, projecting into the filler neck, of the securing element.

According to one advantageous embodiment there is provision that the molded part is secured centrally and coaxially in the tubular securing element, and this is advantageously implemented by the securing element being attached at its inner end to a circular ring which is inserted into the securing element. In other words, the circular ring has an external diameter which corresponds substantially to the internal diameter of the tubular securing element. A securing pin can act on the circular ring through the wall of the securing element in order to secure the molded part in its predetermined position in the securing element.

A further circular ring of the actuation element can then be fitted onto the molded part, which circular ring has substantially the dimensions of a diesel fuel nozzle outlet pipe. In one advantageous embodiment, on this second circular ring there is an actuation arm which engages through the first circular ring of the molded part and, when the second circular ring is pushed on to the point where it fits onto the first circular ring as a result of the insertion of the actuation arm, is capable of opening the closure flap.

According to a further advantageous embodiment there is provision that the securing element has an outlet opening on its tubular wall. This outlet opening can be provided above or below the closure flap. This outlet opening is intended to permit that an incorrect fuel which is inadvertently filled in above the insertion depth of the insert element from the filling opening as far as the closure cover can flow away without passing into the interior of the container. It is to be noted in this regard that it can only be several milliliters of the wrong fuel since only the filling volume corresponding to the cylinder size of the securing element up to the closed closure cover can be filled.

If it is then assumed that the insert element is in use in fuel tanks which are integrally installed in automobiles, the filler neck always has a somewhat inclined installation position. Given an inclined installation position, the fuel which is incorrectly filled in flows along the bottom side of the tubular securing element, with the result that the outlet opening can also be arranged after the closure flap in the direction of flow of the fuel. The outlet opening can then be located in a position with respect to the closure flap in which in the pivoted-up state the closure flap covers the outlet opening.

It is also advantageously provided that the securing element has on its inlet side a tapered portion which is directed toward the outlet side and with which a fuel nozzle outlet pipe, which is to be plugged into the opening in the insert element, is guided onto the end side of the securing element.

Finally, there is advantageously provision that the closure flap has a latching element which interacts with a complementary latching member on the securing element. This can be a locking means in the form of a pawl of the closure flap which engages in a recess in the securing element, or vice versa. The essential factor here is that this locking means is not unlocked, for example, by the force owing to an impact by fuel but instead the locking means can be unlocked by displacement of the actuation element. This ensures that the closure flap can be opened only when the correct diesel fuel nozzle has been selected and the insert element has been inserted, i.e. displacement of the actuation element takes place. For this purpose, the actuation element can be displaced along the locking recess with the result that the locking pawl of the closure flap is pushed back and the locking means is therefore released. All that is then necessary is merely to push the closure flap into the open position counter to its spring prestress. In other words, the force with which the closure flap is held in its seal-forming closed position does not have to be overcome by the insertion force of the fuel nozzle. The latter is only a fraction of this closing force, specifically the spring prestressing force.

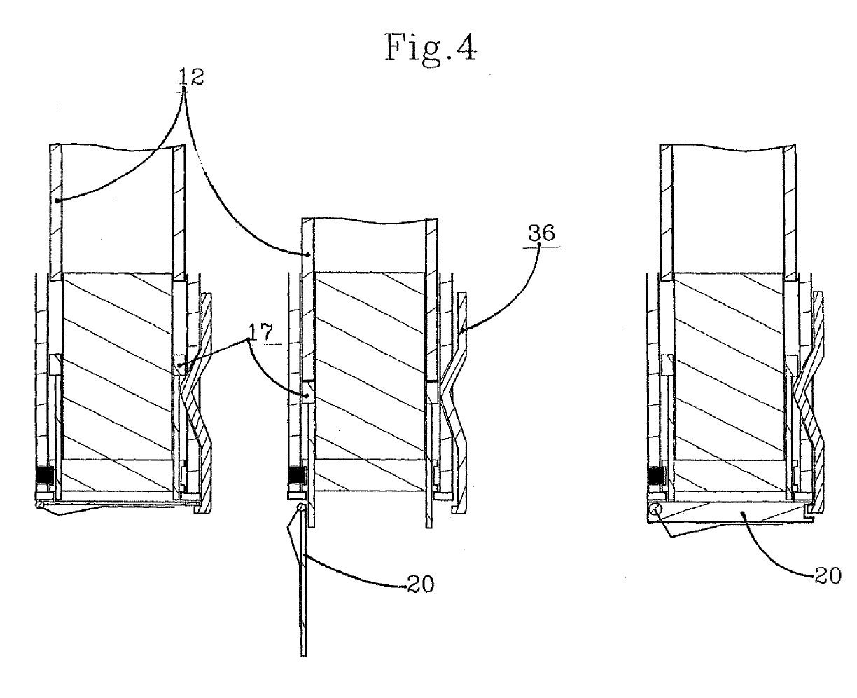

If the pawl is arranged on the closure flap, it is to be ensured that the inserting fuel nozzle does not become stuck with its outlet tube end on the pawl. The pawl is then to be attached at a suitable point on the flap or it is to be ensured that the closure flap is arranged deep in the insertion element or filler neck in such a way that the outlet tube end cannot be pushed beyond the closure flap even at the maximum insertion depth of the outlet tube. According to another embodiment, a type of ramp is also possible on the closure flap, onto which ramp the outlet tube runs up and behind which the pawl of the closure flap is located, with the result that the outlet pipe is lifted over the pawl. Alternatively it is possible to allow the closure flap to become locked in a locking spring which is arranged outside the securing element (see exemplary embodiment in FIG. 4 in this respect).

So that air can continue to escape from the tank even when the filling opening is reduced in size when the fuel nozzle is inserted, the securing element advantageously has recesses in an axial longitudinal direction on its inner face so that air can escape from the container between the outer wall of the fuel nozzle outlet pipe and said inner face of the securing element.

The invention also provides a fuel tank for diesel as claimed in claim 10 or 11 or a mobile fuel can which is intended for diesel fuel.

The invention will now be described in more detail with respect to the appended drawings in which:

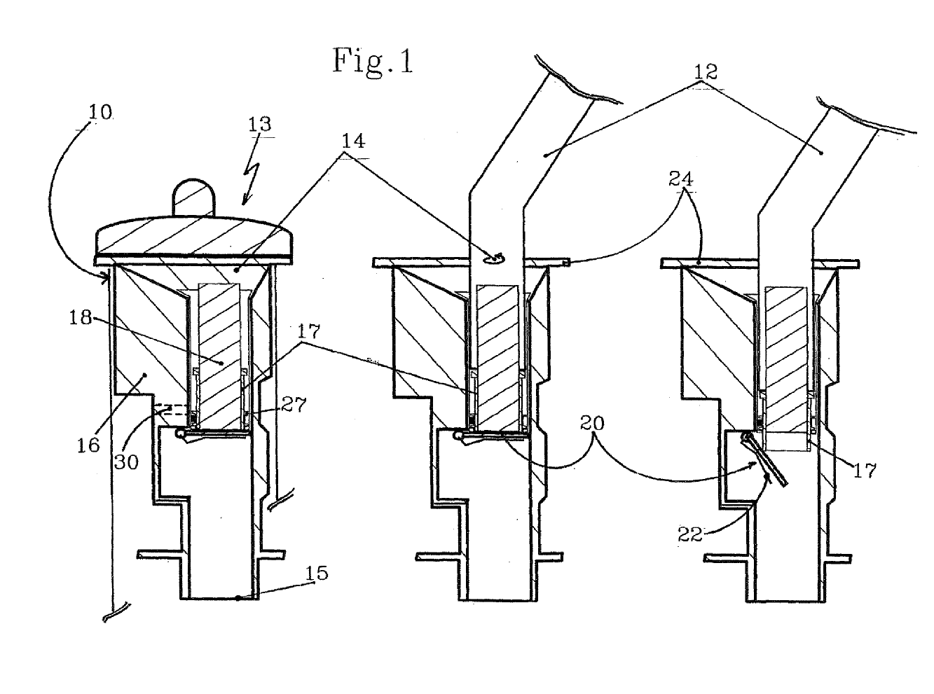

FIG. 1 shows a triple sectional view of the insert element according to the invention, wherein a fuel nozzle outlet pipe inserted in two views;

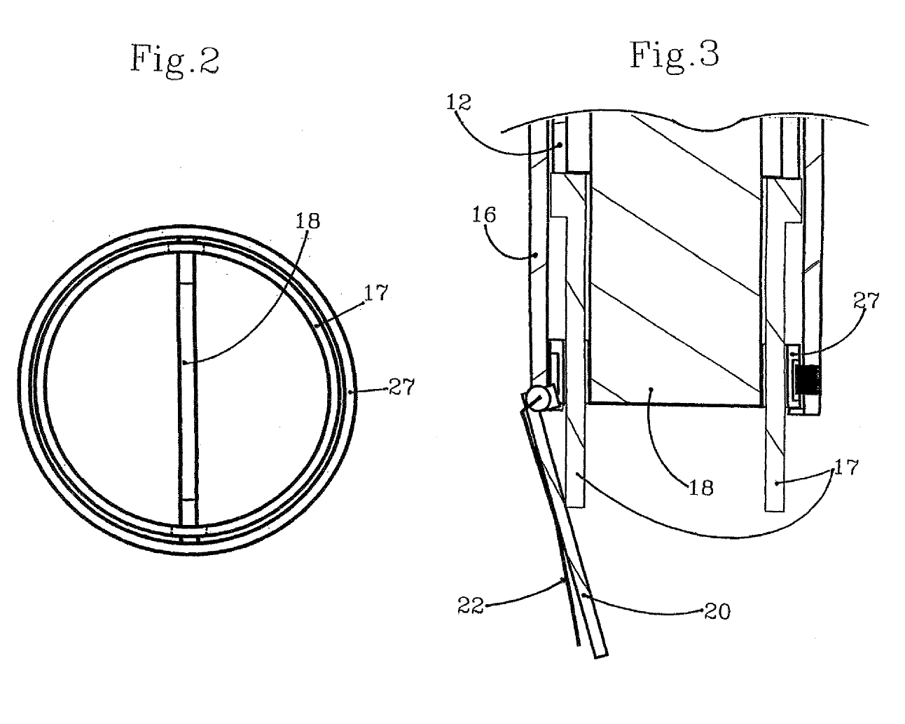

FIG. 2 shows a plan view of the molded part with an actuation element, and

FIG. 3 shows an enlarged partial view of the actuation element of the closure flap.

FIG. 4 shows an embodiment detail relating to the locking means of the closure flap.

FIG. 1 shows the insert element 13 according to the invention in terms of how it is to be positioned in a filling opening 10 of a fuel container. In the left-hand side illustration of FIG. 1, the insert element 13 is shown in the closed state in which a closure cover, if appropriate the original tank closure cover, is fitted on. According to the central illustration in FIG. 1, when the cover is taken off the outlet pipe 12 of the fuel nozzle is inserted into the insert element 13, specifically by means of the molded part 18 until it abuts against the actuation element 17. In the right-hand side illustration in FIG. 1, the fuel nozzle outlet pipe 12 is illustrated inserted further in, with the result that it has already displaced the actuation element 17 partially in the axial direction with respect to the outlet side 15 and has therefore partially pivoted the closure flap 20.

The actuation element 17 has, at the upper end, i.e.

the abutment point of the outlet pipe end of the fuel nozzle, a circular ring with which the insertion depth of the actuation element 17 is limited, specifically until this circular ring impacts against the circular ring 27 to which the molded part 18 is attached in the securing element 16. In this respect, it is apparent from the right-hand side illustration in FIG. 1 that even at the maximum insertion depth of the fuel nozzle outlet pipe the latter cannot be pushed entirely past the closure cover. This aspect is significant when a locking pawl (not shown), which interacts with a locking window (not shown) on the securing element, is located on the closure flap. In the locked state, the pawl which is located in the window is arranged relative to the actuation element in such a way that when displaced out of its position of rest the actuation element can release the pawl from the window and therefore release the locking means. This can be implemented by the actuation element having a pin which impacts against a conical surface of the pawl, wherein the pin is subsequently led on underneath the window in a recess provided in the insertion direction in the securing element.

A funnel, which is directed conically with respect to the outlet side 15 and opens onto a tubular protrusion of the securing element, is provided on the inlet side 14 of the securing element 16. This reduction implements an unambiguous insertion position of a fuel nozzle outlet tube 12. The molded part 18 projects, from this reduced filling opening, in a way which can be clearly seen by anyone who performs refueling of a tank. This reduction also makes it possible to provide a space in the securing element 16 which is necessary for the pivoting of the closure flap 20.

The insertion depth of the insert element in a filler neck is provided with a stop ring 24.

FIG. 2 shows a plan view of the molded part 18, which is secured by means of the circular ring 27 on the internal circumference of the tubular securing element 16, and the actuation element 17. From this drawing it becomes clear that the actuation element 17 must have coaxial cutouts where the lower webs of the securing element 18 connect the securing element to the circular ring 27.

FIG. 3 shows the closure flap 20 and the actuation element 17 in an enlarged detail. The end of a fuel nozzle outlet pipe 12 has been pushed onto the actuation element 17 and has partially displaced the latter in the direction of the outlet side 15 of the securing element. This displacement of the actuation element 17 has partially opened the closure flap 20. The circular ring 27 which attaches the securing element is secured to the securing element 16 by means of a pin, marked as a black block. The closure flap 20 is prestressed with a spring 22 with which the actuation element is also pushed into its position of rest, and the outlet tube of the fuel nozzle is pulled out and the closure flap pivoted back.

FIG. 4 shows a detail according to which the closure flap 20 is locked by means of a locking spring 36. For this purpose, the locking spring 36 is moved by the actuation element 17. When the actuation element is pushed down, the locking spring which is positioned on the external circumference of the securing element is pushed back in such a way that the closure flap 20 is released (see central illustration in FIG. 4). During the insertion of the filling nozzle, the locking spring remains pushed back. The locking spring does also not move back into its position of rest which secures the closure flap 20 until the actuation element is displaced into its position of rest again, specifically not until the last moment of this backward movement of the actuation element when the closure flap has already closed in a seal-forming fashion. In the right-hand side illustration in FIG. 4, a relatively thick closure cover element 20 is shown.

### LIST OF REFERENCE NUMERALS

10 Filling opening of a fuel container
12 Fuel nozzle or the outlet tube thereof
13 Insert element
14 Inlet side
15 Outlet side
17 Actuation element
16 Securing element
18 Molded part
20 Closure flap
22 Spring
24 Stop ring
27 Circular ring
30 Outlet opening
36 Locking spring

1. An insert element (13) for a diesel fuel container which, for the purpose of filling diesel fuel with a fuel nozzle at the filling station end, can be installed in the filling opening (10) of the container, in particular in a filler neck, wherein the insert element (13) has an elongated, substantially tubular securing element (16) which can be fitted into the container opening and has an inlet side (14) and an outlet side (15), in which insert element (13) a molded part (18), which is elongated parallel to the securing element (16) and whose free end side, projecting toward the inlet side, has an external diameter which is smaller than the internal diameter of an outlet pipe (12) of a diesel fuel nozzle but larger than the internal diameter of a gasoline fuel nozzle outlet pipe, is secured, and wherein, in addition, an actuation element (17) which can be displaced coaxially on the inner wall of the securing element (16) is provided, which actuation element (17) is arranged set back behind the end side of the molded part (18) in the direction of the outlet side (15) and is capable, when displaced in the direction of the outlet side (15), of actuating a closure flap (20) which is arranged on the outlet side (15) of the securing element (16) after the actuation element (17).

2. The insert element (13) as claimed in claim 1, characterized in that the securing element (16) has a stop ring (24) with which the insertion depth of the insert element (13) into the filler neck (10) of a fuel container can be limited.

3. The insert element (13) as claimed in claim 1, characterized in that the molded part (18) which is arranged in the securing element (16) projects over the opening plane on the outer edge of the securing element.

4. The insert element (13) as claimed in claim 1, characterized in that the securing element (16) has an external thread with which the insert element (13) can be screwed into the filler neck (10) of a fuel container.

5. The insert element (13) as claimed in claim 1, characterized in that the securing element (16) has, on its outer circumference, projections (36) which interact with the closing element provided on the filler neck (10) of the fuel container to form a bayonet closure.

6. The insert element as claimed in claim 1, characterized in that the molded part (18) is attached at its lower end, i.e. on the inlet side of the insert element, to the securing element (16) by means of a circular ring (27) which is fitted onto the inner wall of the securing element.

7. The insert element as claimed in claim 1, characterized in that the securing element (16) has an outflow opening (30) on its tubular wall.

8. The insert element as claimed in claim 1, characterized in that the securing element (16) has on its inlet side a tapered portion which is directed toward the outlet side and with which a fuel nozzle outlet pipe (12), which is to be plugged into the opening in the insert element, is guided onto the end side of the securing element.

9. The insert element as claimed in claim 1, characterized in that the closure flap (20) has a latching element substantially opposite the coupling point thereof to the securing element (16), which latching element interacts with a complementary latching member on the securing element, wherein the latching element is actuated by the actuation element (17).

10. The insert element as claimed in claim 9, characterized in that the latching element is a locking spring (36) which is positioned on the outer circumference of the securing element, projects partially through a window which is provided in the securing element and abuts here against the actuation element (17), wherein the locking spring has an end which secures the closure flap.

11. A fuel tank or fuel can which is intended for diesel fuel and which has an insert element as claimed in claim 1.

12. A fuel tank or fuel can which is intended for diesel fuel, having a filler neck in which a molded part (18), which is elongated parallel thereto, and whose free end side which projects toward the inlet side has an external diameter smaller than the internal diameter of an outlet pipe (12) of a diesel fuel nozzle but larger than the internal diameter of a gasoline fuel nozzle outlet pipe, is secured, and wherein, in addition, an actuation element (17) which can be displaced coaxially on the inner wall of the securing element (16) is provided, which actuation element (17) is arranged set back behind the end side of the molded part (18) in the direction of the inner side of the tank and is capable, when displaced in the direction of the inner side of the tank, of actuating a closure flap (20) which is arranged after the actuation element (17) in the filling direction.
